(19) United States
(12) Patent Application Publication
(10) Pub. No.: US 2016/0009016 A1
(43) Pub. Date: Jan. 14, 2016

(54) PROCESS FOR MAKING A PLASTIC CONTAINER

(71) Applicant: WELL MAX BEAUTY LAB CO., LTD., Tainan City (TW)

(72) Inventor: Teng-Huei WANG, Tainan City (TW)

(21) Appl. No.: 14/326,533

(22) Filed: Jul. 9, 2014

(51) Int. Cl. B29C 49/06; B29D 22/00

(52) U.S. Cl. CPC B29C 49/06; B29D 22/003; B29K 2023/00

(57) ABSTRACT

A process for making a plastic container includes (a) grinding first pellets made from a polyolefin-based material to obtain fine powders, (b) preparing a blend for injection molding, the blend including a major amount of second pellets made from polyethylene terephthalate and a minor amount of the fine powders, (c) causing the blend to proceed through a heating zone so as to heat the blend, (d) injecting the heated blend into an injection mold to obtain a preform, and (e) subjecting the preform to blow molding. The fine powders have an average particle size not greater than 500 μm.

### BACKGROUND OF THE INVENTION

1. Field of the Invention

This invention relates to a process for making a plastic container, more particularly to a process for making a plastic container with a pearly gloss.

2. Description of the Related Art

Polyethylene terephthalate (PET) is a transparent material which is tough, light-weight, and recyclable, and which has good acid/base resistance. Thus, PET is normally used to make plastic containers.

European patent application publication no. 0456929 discloses a thermoplastic resin for making the plastic containers with a pearl gray glossiness. The thermoplastic resin is a composition prepared by adding polymethylpentene (0.01˜0.9 wt %) to polyester (99.1˜99.99 wt %). A preferred example of the polyester is PET. The composition is subjected to biaxial orientation after molding of preformation. When the composition includes polyolefin (such as polyethylpentene, polyethylene, polypropylene, EVA, etc.) in an amount of 10 wt %, the container has a pearl gray glossiness, but the moldability is poor (see Table 1), i.e., the container has an uneven thickness and flow marks on its surface. From the result of Table 1, it is noted that only when the polyolefin was polymethylpentene and was in an amount less than 1 wt % could the surface of the container have a pearly gloss and be free from flow marks.

### SUMMARY OF THE INVENTION

Therefore, an object of the present invention is to provide a process for making a plastic container with a surface that has a pearly gloss and is free from flow marks. Moreover, for making the plastic container, polyolefin can be used in a wider range.

Accordingly, a process for making a plastic container of this invention includes the steps of:

(a) grinding first pellets made from a polyolefin-based material to obtain fine powders which have an average particle size not greater than 500 μm;

(b) preparing a blend for injection molding, the blend including a major amount of second pellets which are made from polyethylene terephthalate and a minor amount of the fine powders;

(c) causing the blend to proceed through a heating zone so as to heat the blend to an injection temperature;

(d) injecting the heated blend into an injection mold to obtain a preform; and

(e) subjecting the preform to blow molding.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a flow diagram showing a preform forming step of a process for making a plastic container according to a preferred embodiment of this invention;

FIG. 2 is a flow diagram showing a preform blow molding step of the process;

FIG. 3 shows the surface appearance of the plastic container of Example 1;

FIG. 4 shows the surface appearance of the plastic container of Comparative Example 1;

FIG. 5 shows the surface appearance of the plastic container of Comparative Example 2;

FIG. 6 shows the surface appearance of the plastic container of Comparative Example 3;

FIG. 7 shows the surface appearance of the plastic container of Comparative Example 4; and

FIG. 8 shows the surface appearance of the plastic container of Comparative Example 5.

### DETAILED DESCRIPTION OF THE PREFERRED EMBODIMENTS

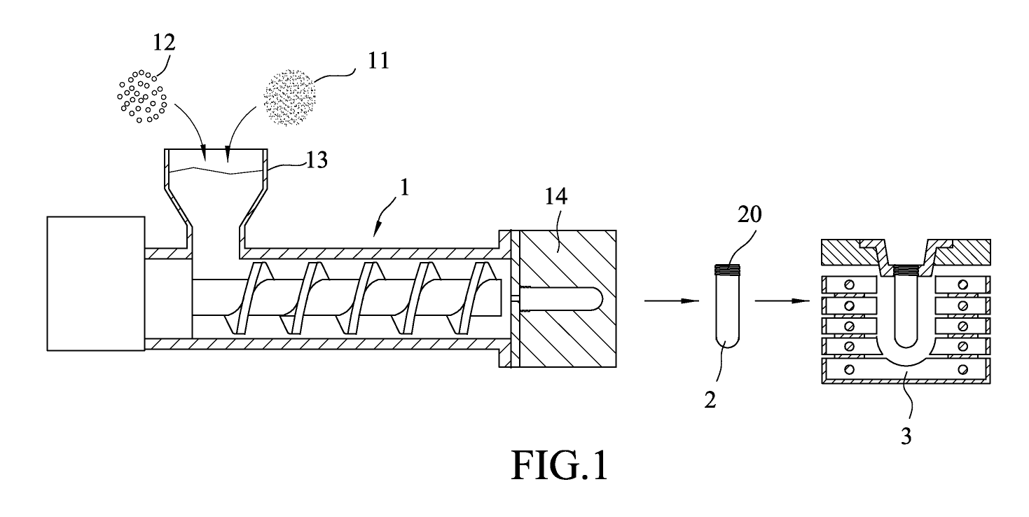

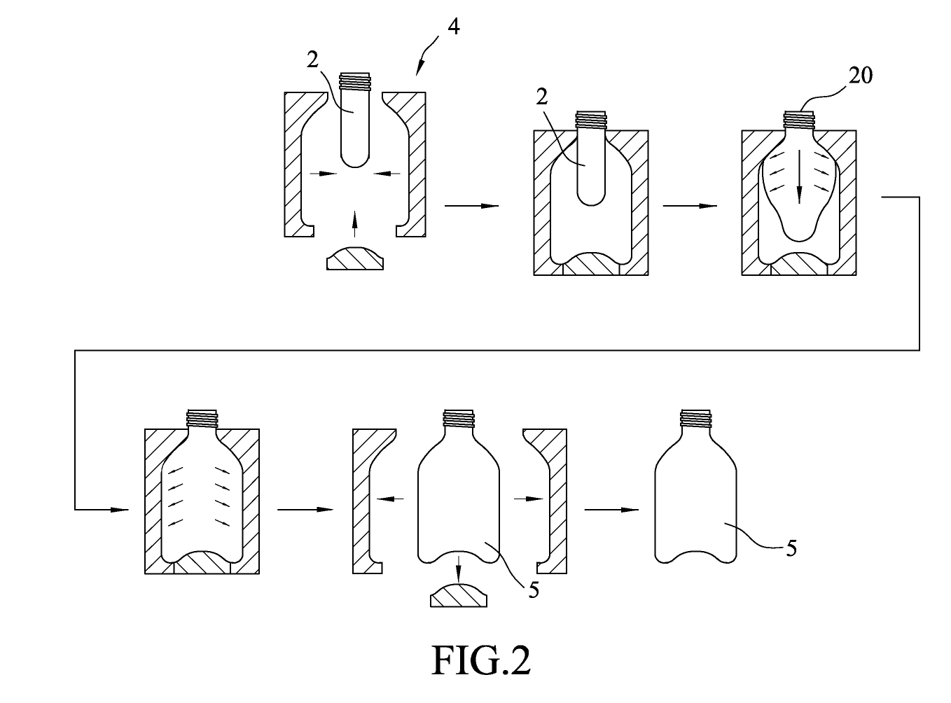

With reference to FIGS. 1 and 2, a process for making a plastic container according to a preferred embodiment of this invention includes steps (a) to (e).

In step (a), first pellets made from a polyolefin-based material are ground to obtain fine powders 11 which have an average particle size not greater than 500 μm. Preferably, the average particle size is not greater than 100 μm. Non-limited examples of the polyolefin-based material include polyethylene (PE), polypropylene (PP), polymethylpentene (PMP), polyolefin elastomer (POE), and ethylene-vinyl acetate copolymer (EVA). Examples of PE include low-density polyethylene (LDPE), high-density polyethylene (HDPE), linear low-density polyethylene (LLDPE), etc.

In step (b), a blend for injection molding is prepared. The blend includes a major amount of second pellets 12 made from polyethylene terephthalate (PET) and a minor amount of the fine powders 11. In this embodiment, based on a total weight of the blend, the fine powders 11 are in an amount ranging from 1 wt % to 10 wt %, and the second pellets 12 are in an amount ranging from 90 wt % to 99 wt %. The second pellets 12 have an average particle size much greater than that of the fine powders 11. As shown in FIG. 1, the fine powders 11 and the second pellets 12 are poured into a hopper 13 of an injection molding machine 1 and mixed into a blend.

In step (c), the blend is caused to proceed through a heating zone so as to heat the blend to an injection temperature which should be higher than the melting point of PET (250° C.). In this embodiment, the injection temperature ranges from 250° C. to 300° C., and the heating zone is divided into at least three consecutive heating regions such that the blend proceeding sequentially through the heating regions is heated at progressively increasing temperatures up to the injection temperature. In the preferred embodiment, the heating zone is divided into five consecutive heating regions for heating the blend respectively at 250° C., 265° C., 275° C., 275° C., and 275° C.

In step (d), the heated blend is injected into an injection mold 14 to obtain a preform 2 which is a tube-like piece with an opening 20 at one end thereof.

In step (e), the preform 2 is placed and held in a blow-molding mold 4 and is subjected to blow molding at a blow-molding temperature to obtain a plastic container 5. In this step, compressed air is blown into the preform 2 through the opening 20 of the preform 2. The blow-molding temperature should be higher than the glass-transition temperature of PET (80° C.). In this embodiment, the blow-molding temperature ranges from 80° C. to 130° C.

In this embodiment, before step (e), the preform 2 is disposed in a temperature adjusting chamber with temperature adjusters 3, as shown in FIG. 1 until the temperature of the preform 2 is adjusted to the blow-molding temperature for subsequent blow molding.

Please note that, after step (d), the preform 2 can be cooled to the blow-molding temperature in the temperature adjusting chamber. Alternatively, the preform 2 can be cooled to room temperature for storage, and then is heated to the blow-molding temperature in the temperature adjusting chamber.

In above-mentioned European patent publication, the amount of polyolefin added to the PET material is limited to less than 1 wt %, because, from the aspect of thermodynamics, when the amount of polyolefin in the PET material is relatively high, the polyolefin in the PET material tends to aggregate as the polyolefin and the PET material tend to have a minimum contact area therebetween so as to reduce surface energy. This aggregation will result in a phase separation between the polyolefin and the PET material. In addition, the polyolefin and the PET material materials have different heat transfer coefficients. Thus, the plastic container obtained in the above-mentioned European patent publication may have uneven thickness and flow marks.

In the case that the amount of the polyolefin is relatively low, entropy of the blend is a dominating factor, and the polyolefin can be evenly dispersed in the PET material. That is, although an even dispersion of the polyolefin may result in relatively high surface energy, the blend will have a relatively large entropy and phase separation is thus less likely to occur. However, with an increase in the amount of the polyolefin, the surface energy becomes the dominating factor, and phase separation is likely to occur.

The inventor of this invention found that when pellets of polyolefin are ground into fine powders and the amount of polyolefin in the blend is not greater than 10 wt %, the entropy of the blend is still a dominating factor and phase separation can be effectively alleviated.

The present invention will now be explained in more detail below by way of the following examples and comparative examples.

### EXAMPLE 1 (EX 1)

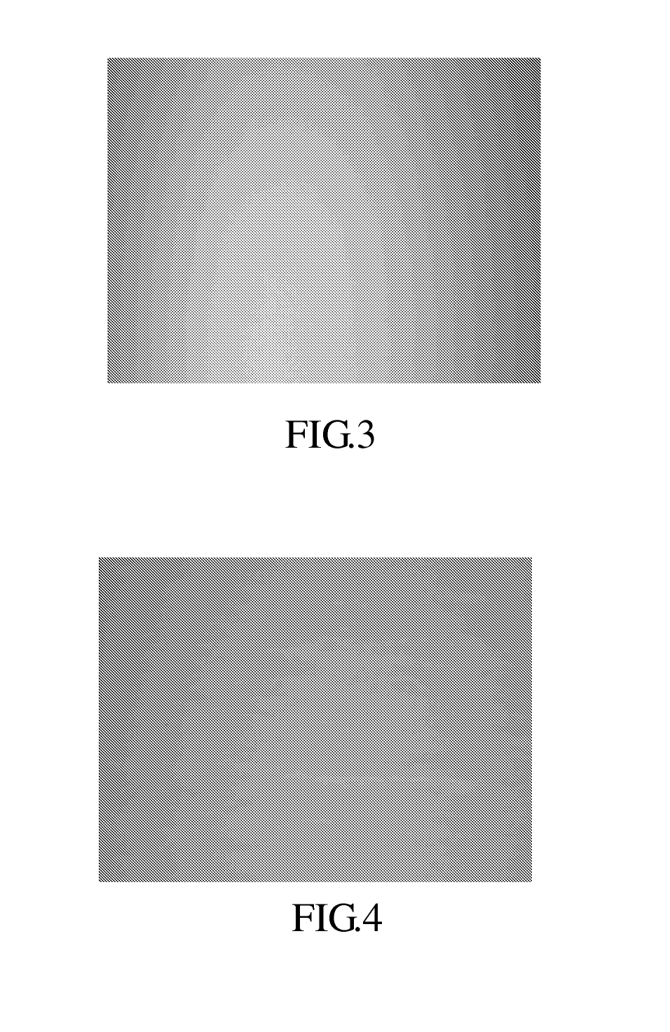

Pellets of polymethylpentene (PMP) (density: 0.84 g/cm³, softening point: 170° C., melt flow index: 22) were ground into fine powders which had an average particle size of 500 μm. Pellets of polyethylene terephthalate (PET) (density: 1.40 g/cm³, PDI (polydispersity index): 1.48, IV (intrinsic viscosity): 0.85±0.02) were also prepared. The PET pellets were not ground and had a millimeter scale size which was much greater than the average particle size of the PMP fine powders. The PMP fine powders and the PET pellets were poured into a hopper of an injection molding machine for preparing a blend of the PMP fine powders (5 wt %) and the PET pellets (95 wt %). The blend was caused to proceed through five heating regions of the injection molding machine which were kept at 250° C., 265° C., 275° C., 275° C., and 275° C., respectively. Thereafter, the blend was injected into an injection mold to obtain a preform. The preform was disposed in a chamber with temperature adjusters until the temperature of the preform reached 100° C. The preform was then removed from the chamber, placed and held in a blow-molding mold, and subjected to blow molding. During blow molding, compressed air was blown into the preform to obtain a plastic container. The temperatures at upper, middle, and lower segments of the preform during blow molding were measured and are shown in the flowing Table 1. A maximum temperature difference among the three measured temperatures is also shown in Table 1. The appearance of the plastic container is shown in FIG. 3.

### EXAMPLE 2 (EX 2)

A plastic container of Example 2 was prepared by a process similar to that of Example 1, except that the PMP pellets were replaced by pellets of polyethylene (PE) (density: 0.920 g/cm3, MI (melt index): 0.7, softening point: 90° C.). Thus, in this example, PE fine powders were obtained. A blend including the PE fine powders (10 wt %) and the PET pellets (90 wt %) was prepared for forming the plastic container. The temperatures at upper, middle, and lower segments of the preform during blow molding are shown in Table 1. A maximum temperature difference among the three measured temperatures is also shown in Table 1.

### EXAMPLE 3 (EX 3)

A plastic container of Example 3 was prepared by a process similar to that of Example 2, except that the blend included PE fine powders (1 wt %) and PET pellets (99 wt %). The temperatures at upper, middle, and lower segments of the preform during blow molding are shown in Table 1. A maximum temperature difference among the three measured temperatures is also shown in Table 1.

### EXAMPLE 4 (EX 4)

A plastic container of Example 4 was prepared by a process similar to that of Example 1, except that the PMP pellets were replaced by pellets of polypropylene (PP) (density: 0.899 g/cm3, MFR (melt flow rate): 18, haze: 25˜30%). Thus, in this example, PP fine powders were obtained. A blend including PP fine powders (10 wt %) and PET pellets (90 wt %) was prepared for forming the plastic container. The temperatures at upper, middle, and lower segments of the preform during blow molding are shown in Table 1. A maximum temperature difference among the three measured temperatures is also shown in Table 1.

### EXAMPLE 5 (EX 5)

A plastic container of Example 5 was prepared by a process similar to that of Example 4, except that the blend included PP fine powders (1 wt %) and PET pellets (99 wt %). The temperatures at upper, middle, and lower segments of the preform during blow molding are shown in Table 1. A maximum temperature difference among the three measured temperatures is also shown in Table 1.

### EXAMPLE 6 (EX 6)

A plastic container of Example 6 was prepared by a process similar to that of Example 3, except that the PE fine powders had an average particle size of 100 μm. The temperatures at upper, middle, and lower segments of the preform during blow molding are shown in Table 1. A maximum temperature difference among the three measured temperatures is also shown in Table 1.

### EXAMPLE 7 (EX 7)

A plastic container of Example 7 was prepared by a process similar to that of Example 5, except that the PP fine powders had an average particle size of 100 μm. The temperatures at upper, middle, and lower segments of the preform during blow molding are shown in Table 1. A maximum temperature difference among the three measured temperatures is also shown in Table 1.

### COMPARATIVE EXAMPLE 1 (CE 1)

A plastic container of Comparative Example 1 was prepared by a process similar to that of Example 1, except that the PMP pellets were not ground and had an average particle size of 4 mm. The temperatures at upper, middle, and lower segments of the preform during blow molding are shown in Table 1. A maximum temperature difference among the three measured temperatures is also shown in Table 1. The appearance of the plastic container obtained is shown in FIG. 4.

### COMPARATIVE EXAMPLE 2 (CE 2)

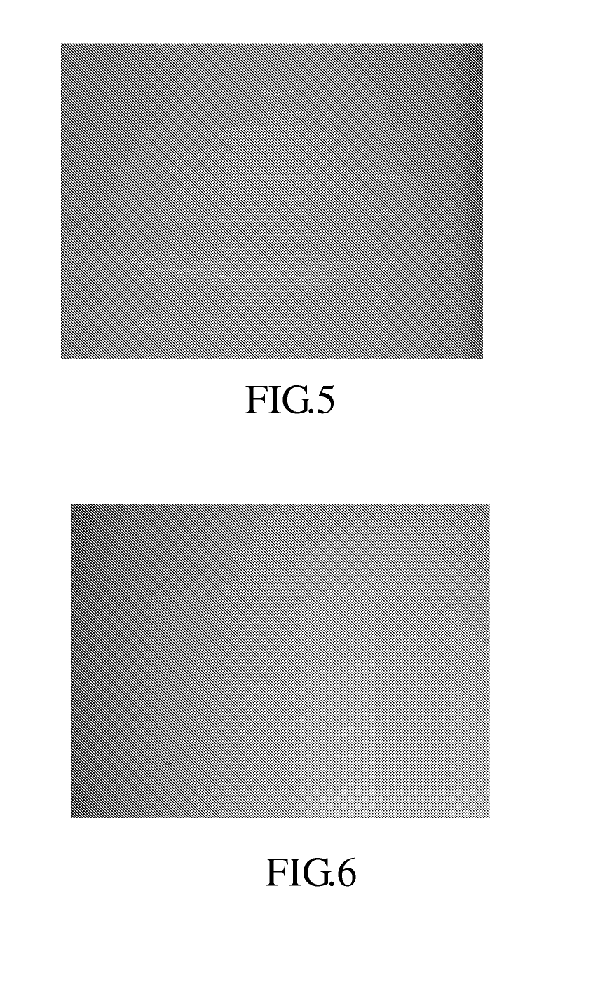

A plastic container of Comparative Example 2 was prepared by a process similar to that of Example 2, except that the PE pellets were not ground and had an average particle size of 5 mm. The temperatures at upper, middle, and lower segments of the preform during blow molding are shown in Table 1. A maximum temperature difference among the three measured temperatures is also shown in Table 1. The appearance of the plastic container obtained is shown in FIG. 5.

### COMPARATIVE EXAMPLE 3 (CE 3)

A plastic container of Comparative Example 3 was prepared by a process similar to that of Example 2, except that the blend included PE fine powders (12 wt %) and PET pellets (88 wt %). The temperatures at upper, middle, and lower segments of the preform during blow molding are shown in Table 1. A maximum temperature difference among the three measured temperatures is also shown in Table 1. The appearance of the plastic container obtained is shown in FIG. 6.

### COMPARATIVE EXAMPLE 4 (CE 4)

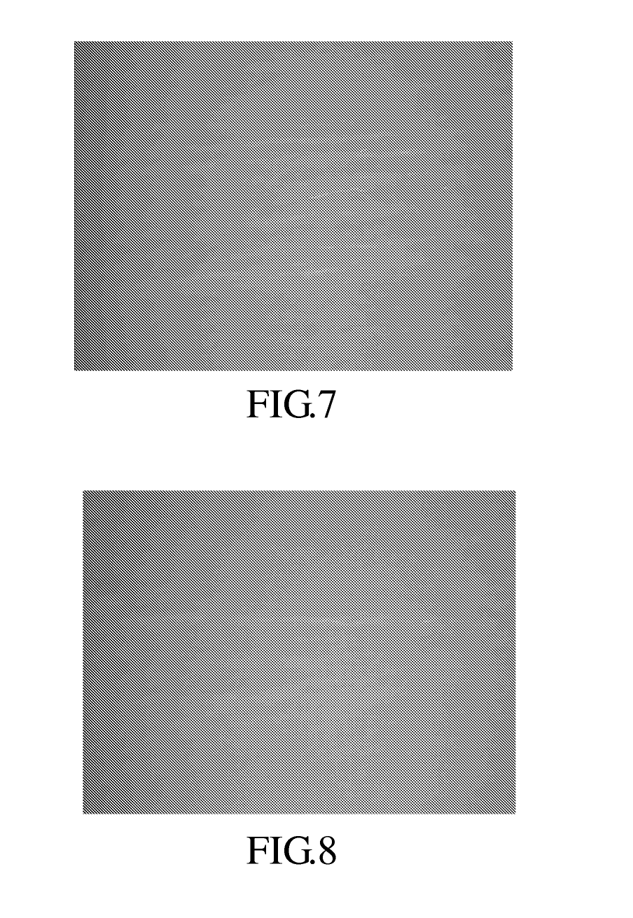

A plastic container of Comparative Example 4 was prepared by a process similar to that of Example 4, except that the PP pellets were not ground and had an average particle size of 4 mm. The temperatures at upper, middle, and lower segments of the preform during blow molding are shown in Table 1. A maximum temperature difference among the three measured temperatures is also shown in Table 1. The appearance of the plastic container obtained is shown in FIG. 7.

### COMPARATIVE EXAMPLE 5 (CE 5)

A plastic container of Comparative Example 5 was prepared by a process similar to that of Example 4, except that the blend included PP fine powders (12 wt %) and PET pellets (88 wt %). The temperatures at upper, middle, and lower segments of the preform during blow molding are shown in Table 1. A maximum temperature difference among the three measured temperatures is also shown in Table 1. The appearance of the plastic container obtained is shown in FIG. 8.

From the results shown in Table 1, it can be found that when the average particle size of the fine powders of polyolefin was not greater than 0.5 mm (500 μm) (Examples 1˜7), the maximum temperature difference among the temperature at the three segments of the preform during blow molding is less than 10° C. When the average particle size of the fine powders of polyolefin was not greater than 0.1 mm (100 μm) (Examples 6˜7), the maximum temperature difference among the temperatures at the three segments of the preform during blow molding is less than 4° C. When the average particle size of the fine powders of polyolefin was greater than 0.5 mm (Comparative Examples 1, 2, and 4) or when the amount of the fine powders of polyolefin was greater than 10 wt % (Comparative Examples 3 and 5), the maximum temperature difference among the temperatures at the three segments of the preform during blow molding is not less than 10° C. This shows that, in comparison with Comparative Examples 1˜5, the preforms made in Examples 1˜7, especially the preforms made in Examples 6˜7, can be evenly heated during blow molding, and that the plastic containers made in Examples 1˜7 are less likely to have flow marks.

It can be seen from FIGS. 3˜8 that the appearance of the plastic container made in Example 1 does not have any flow mark, but there are flow marks on the plastic containers made in Comparative Examples 1˜5.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

TABLE 1

| Examples/Comparative Examples | | EX 1 | EX 2 | EX 3 | EX 4 | EX 5 | EX 6 | EX 7 | CE 1 | CE 2 | CE 3 | CE 4 | CE 5 |
|---|---|---|---|---|---|---|---|---|---|---|---|---|---|
| PET | Amount (wt %) | 95 | 90 | 99 | 90 | 99 | 99 | 99 | 95 | 90 | 88 | 90 | 88 |
| PMP | Amount (wt %) | 5 | | | | | | | 5 | | | | |
| | Avg. Particle Size(mm) | 0.5 | | | | | | | 4 | | | | |
| PE | Amount (wt %) | | 10 | 1 | | | 1 | | | 10 | 12 | | |
| | Avg. Particle Size(mm) | | 0.5 | 0.5 | | | 0.1 | | | 5 | 0.5 | | |
| PP | Amount (wt %) | | | | 10 | 1 | | 1 | | | | 10 | 12 |
| | Avg. particle size (mm) | | | | 0.5 | 0.5 | | 0.1 | | | | 4 | 0.5 |
| Heating stage (° C.) | First heating region | 250 | 250 | 250 | 250 | 250 | 250 | 250 | 250 | 250 | 250 | 250 | 250 |
| (tolerance of ±2° C.) | Second heating region | 265 | 265 | 265 | 265 | 265 | 265 | 265 | 265 | 265 | 265 | 265 | 265 |
| | Third heating region | 275 | 275 | 275 | 275 | 275 | 275 | 275 | 275 | 275 | 275 | 275 | 275 |
| | Fourth heating region | 275 | 275 | 275 | 275 | 275 | 275 | 275 | 275 | 275 | 275 | 275 | 275 |
| | Fifth heating region | 275 | 275 | 275 | 275 | 275 | 275 | 275 | 275 | 275 | 275 | 275 | 275 |
| Perform (° C.) | Upper segment | 98 | 94 | 100 | 100 | 108 | 101 | 109 | 90 | 87 | 89 | 93 | 95 |
| (tolerance of ±2° C.) | Middle segment | 97 | 93 | 99 | 101 | 107 | 101 | 110 | 92 | 92 | 93 | 99 | 102 |
| | Lower segment | 103 | 101 | 103 | 108 | 111 | 104 | 111 | 100 | 99 | 100 | 105 | 107 |
| | Max. temperature | 6 | 8 | 4 | 8 | 4 | 3 | 2 | 10 | 12 | 11 | 12 | 12 |
| | difference | | | | | | | | | | | | |

What is claimed is:

1. A process for making a plastic container, comprising the steps of:
(a) grinding first pellets made from a polyolefin-based material to obtain fine powders which have an average particle size not greater than 500 μm;
(b) preparing a blend for injection molding, the blend including a major amount of second pellets which are made from polyethylene terephthalate and a minor amount of the fine powders;
(c) causing the blend to proceed through a heating zone so as to heat the blend to an injection temperature;
(d) injecting the heated blend into an injection mold to obtain a preform; and
(e) subjecting the preform to blow molding.

2. The process of claim 1, wherein, based on a total weight of the blend, the fine powders are in an amount ranging from 1 wt % to 10 wt %, and the second pellets are in an amount ranging from 90 wt % to 99 wt %.

3. The process of claim 1, wherein the polyolefin-based material is selected the group consisting of polyethylene, polypropylene, polymethylpentene, polyolefin elastomer, and ethylene-vinyl acetate copolymer.

4. The process of claim 1, wherein the injection temperature ranges from 250° C. to 300° C.

5. The process of claim 4, wherein the heating zone is divided into three consecutive heating regions such that the blend proceeding sequentially through the heating regions is heated at progressively increasing temperatures up to the injection temperature.

6. The process of claim 1, wherein, before step (d), the preform is maintained at a blow-molding temperature ranging from 80° C. to 130° C. for subsequent blow molding.
